(19) United States
(12) Patent Application Publication
(10) Pub. No.: US 2005/0179817 A1
(43) Pub. Date: Aug. 18, 2005

(54) Video signal display unit

(75) Inventor: Eiko Kida, Osaka (JP)

Correspondence Address: MCDERMOTT WILL & EMERY LLP, 600 13TH STREET, N.W., WASHINGTON, DC, 20005-3096, US

(73) Assignee: Matsushita Electric Industrial Co., Ltd.

(21) Appl. No.: 11/033,629

(22) Filed: Jan. 13, 2005

(30) Foreign Application Priority Data
Jan. 14, 2004 (JP) 2004-006413

(51) Int. Cl. H04N 11/20

(52) U.S. Cl. 348/556; 348/445

(57) ABSTRACT

An image-level detecting section detects luminance levels in detection areas specified by a video signal processing control section. The video signal processing control section analyzes the detection results to determine the position and range of a non-picture area, and then calculates an optimum vertical magnification which allows only a video signal area to be displayed in the same size as the screen size of an output monitor. A video signal processing circuit clips only the video signal area based on a control signal provided from the video signal processing control section and magnifies the video signal area, thereby displaying the video signal area that should be viewed without causing any disappearance thereof.

### CROSS-REFERENCE TO RELATED APPLICATION

The disclosure of Japanese Patent Application No.2004-006413 filed on Jan. 14, 2004 including specification, drawings and claims is incorporated herein by reference in its entirety.

### BACKGROUND OF THE INVENTION

The present invention relates to video signal display units for changing broadcasted video signals, video signals (main video signals) recorded on disc media or the like, or sub video signals such as character information, to optimum image sizes according to output monitors.

FIG. 10 illustrates an exemplary configuration of a conventional video signal display unit disclosed in Japanese Laid-Open Publication No. 2002-16884. The reference numeral 41 denotes a disc on which a video signal and a flag indicating the aspect ratio of the video signal are recorded. The reference numeral 42 represents a pickup for transforming the information signal recorded on the disc 41 to an electrical signal. The reference numeral 43 represents a disc-rotating device for rotating the disc 41 at a rotation speed suitable for reproduction.

The reference numeral 44 denotes an interlaced scan video signal reproducing circuit for outputting to a first aspect ratio converting circuit 46 a video signal obtained by decoding the signal recorded on the disc 41. The reference numeral 45 denotes a material determining circuit for determining the aspect ratio of the video signal recorded on the disc 41 based on output from the pickup 42. The reference numeral 48 indicates a first aspect ratio setting section for setting an aspect ratio for an output monitor connected to the video signal display unit. The reference numeral 47 denotes a first control circuit for generating a control signal for the first aspect ratio converting circuit 46 based on output from the material determining circuit 45 and output from the first aspect ratio setting section 48.

The first aspect ratio converting circuit 46 outputs through a video signal output terminal 49 an output signal generated based on the video signal output from the interlaced scan video signal reproducing circuit 44 and the control signal output from the first control circuit 47.

FIG. 11 indicates output processing performed in a case where an input video signal in the conventional video signal display unit thus constructed is a video signal which contains a non-picture area in the upper and lower portions thereof, for example (hereinafter referred to as a “4:3 letterbox image”.)

As shown in FIG. 11A, in the case of a monitor with an aspect ratio of 4:3, the 4:3 letterbox image can be displayed on the monitor at the correct aspect ratio.

On the other hand, as shown in FIG. 11B, when the 4:3 letterbox image is displayed on a monitor with an aspect ratio of 16:9, the 4:3 letterbox image cannot be displayed at the correct aspect ratio and extended in the horizontal direction.

To address this, as shown in FIG. 11C, upon the receipt of the 4:3 letterbox image, the conventional video signal display unit magnifies upwardly and downwardly a video signal area of the input video signal, which is the area of the input video signal other than the non-picture area contained in the upper and lower portions thereof, before displaying the 4:3 letterbox image,

However, as shown in FIG. 11D, in video signals which contain a non-picture area, where the non-picture area is inserted and how many lines the non-picture area includes on the screen are not always the same. This causes a problem with the video signal displayed by the conventional video signal display unit. More specifically, assuming that the non-picture area is included in the upper and lower portions of the input video signal, the conventional video signal display unit removes the non-picture area by removing a fixed number of lines and extends upwardly and downwardly the remaining signal area as the video signal, and then displays the resultant video signal. The displayed video signal has a problem in that the video signal area that should be viewed disappears partially.

Moreover, as shown in FIG. 12A, when a 4:3 letterbox image, which includes a non-picture area and in which character information is superimposed on both the non-picture area and a video signal area, is displayed on a monitor with an aspect ratio of 16:9, the 4:3 letterbox image cannot be displayed at the correct aspect ratio and is extended in the horizontal direction.

To deal with this, the above-mentioned output processing is necessary in which the video signal area other than the non-picture area is magnified upwardly and downwardly and then displayed. However, if the clipping process is carried out using a fixed position or a fixed number of lines, a problem occurs in that the character information partially disappears, as shown in FIG. 12B.

To avoid such a situation, as shown in FIG. 12C, a technique has been proposed in which the display position of the character information is shifted upwardly on the screen and the video signal area is then magnified upwardly and downwardly. Nevertheless, the composition position and range in which the character information is superimposed on the video signal are not always the same and it has therefore been difficult to perform display processing which is optimum for all combinations.

### SUMMARY OF THE INVENTION

As mentioned above, when the conventional video signal display unit determines that an input signal includes a non-picture area, the video signal display unit specifies the position and range of the non-picture area using a fixed position or a fixed number of lines and magnifies, as a video signal area, the area in the input video signal other than the non-picture area at a fixed magnification before displaying the video signal area.

However, video signals to be displayed have various features, such that the insert position of the non-picture area and the number of lines in the non-picture area on the screen are not always the same. It is thus not desirable to perform separation between the non-picture area and the video signal area using a fixed position or a fixed number of lines. For instance, the conventional video signal display unit has a problem in that if a video signal is included in a signal area which has been determined to be a non-picture area, the video signal that should be displayed disappears.

The conventional video signal display unit has another problem. In the case of an input video signal in which character information is superimposed on both a video signal area and a non-picture area, if only the video signal area of the input video signal other than the non-picture area is clipped and displayed, the portion of the character information contained in the non-picture area disappears.

The present invention has been made to overcome the above problems, and an object thereof is to provide a video signal display unit in which the range of a non-picture area in an input video signal is detected line by line to allow clipping of a video signal area from the input video signal without losing any part of the video signal area, and the obtained video signal area is changed to an optimum image size so as to be of the same size as the screen size of an output monitor.

Another object of the present invention is to provide a video signal display unit in which if the display position of character information is set to be included in both a video signal area and a non-picture area in an input video signal, the display position of the character information is shifted or the portion of the non-picture area in which the character information is contained is also clipped as the video signal, before the video signal is changed in size, thereby preventing both the video signal and the character information from disappearing.

An inventive video signal display unit includes: image-level detecting means for detecting line by line luminance signal levels in predetermined detection areas in an input video signal input from a video signal input terminal; aspect-ratio setting means for setting an aspect ratio of an output monitor connected with a video signal output terminal; video-signal processing control means for analyzing line positions of a video signal area and a non-picture area in the input video signal based on detection result obtained by the image-level detecting means, generating a first control signal for respecifying the detection areas based on result of the analysis, and outputting the first control signal to the image-level detecting means, and also for generating a second control signal indicating, based on the detection result and the aspect ration, a range of an area to be clipped as the video signal area in the input video signal and a magnification at which the range of the clipped area is changed in size; and a video signal processing circuit for clipping only the video signal area from the input video signal based on the second control signal, magnifying the clipped video signal area at the magnification, and outputting the magnified video signal area to the video signal output terminal.

In the inventive video signal display unit, the video signal processing control means may specify the range of the area to be clipped as the video signal area, based on one of the detection areas which is for the non-picture area in the input video signal.

In the inventive video signal display unit, the image-level detecting means may be configured to detect at least one of luminance signal average levels, luminance signal maximum levels, and luminance signal minimum levels in the detection areas in the input video signal, and the video signal processing control means may be configured to compare the luminance signal levels detected by the image-level detecting means with a threshold value established in advance, thereby determining whether the signal in the detection areas in the input video signal indicates the video signal area or the non-picture area.

In the inventive video signal display unit, the video signal input to the image-level detecting means and the video signal processing circuit may be a main video signal or a composite signal in which the main video signal and a sub video signal are combined.

In the inventive video signal display unit, the second control signal may control the video signal processing circuit so that the size of an image obtained by clipping only the video signal area other than the non-picture area based on detection result in which a range of the non-picture area is detected for each of frames in the input video signal is changed to a size substantially equal to the screen size of an output monitor.

In the inventive video signal display unit, the second control signal may control the video signal processing circuit so that an image obtained by clipping the video signal area in such a manner that a disappearing portion of the video signal area is minimized, based on detection result in which a range of the non-picture area is detected for each of frames in the input video signal is enlarged at the predetermined magnification.

The inventive video signal display unit may further include sub video signal composition position setting means for setting a composition position in which a sub video signal is combined with a main video signal. And in the inventive video signal display unit, the video signal processing control means may be configured to generate the second control signal also indicating the composition position set by the sub video signal composition position setting means, when the main video signal is input to the video signal input terminal while the main video signal and the sub video signal are input to the video signal processing circuit, and the video signal processing circuit may be configured to combine the sub video signal with the main video signal in the composition position based on the second control signal, after the size of the main video signal has been changed.

In the inventive video signal display unit, the video signal processing circuit may be configured so that when a display range of the sub video signal is contained in both a display range of the video signal area of the main video signal and a display range of the non-picture area, the video signal processing circuit shifts the display position of the sub video signal so that the display range of the sub video signal overlaps only the display range of the main video signal, before the video signal processing circuit combines the main video signal and the sub video signal.

In the inventive video signal display unit, the input video signal input from the video signal input terminal may be a composite signal in which a main video signal and a sub video signal have been combined beforehand.

In the inventive video signal display unit, the video signal processing circuit may be configured so that when a display range of the sub video signal is contained in both a display range of the video signal area and a display range of the non-picture area in the input video signal, the video signal processing circuit clips the display ranges of the video signal area and sub video signal area as the video signal area of the input video signal, and changes the size of the clipped video signal area.

In the inventive video signal display units, the range of a non-picture area in an input video signal is detected line by line, allowing a video signal area to be clipped from the input video signal without losing any part of the video signal area. Accordingly, the clipped video signal area can be changed to an optimum size so as to be of the same size as the screen size of an output monitor.

Also, when the display position of character information is set to be included in both a video signal area and a non-picture area in an input video signal, the display range of the character information is shifted into the display range of the video signal so that the character information is superimposed on the video signal, thereby preventing the character information from disappearing.

In the case of a composite signal in which character information is superimposed on a video signal, if the character information is included in both the video signal area and a non-picture area, a portion of the non-picture area containing the character information is also clipped as the video signal, and the obtained video signal is changed to an optimum image size and an optimum aspect ratio according to the screen size of an output monitor. Then, the video signal and the character information are both displayed without losing any part thereof.

### BRIEF DESCRIPTION OF THE DRAWINGS

FIG. 1 is a block diagram illustrating the configuration of a video signal display unit according to a first embodiment of the present invention.

FIG. 2 is a flow chart indicating how the video signal display unit of the first embodiment performs process steps for specifying the range of a video signal area in an input video signal.

FIG. 3 is a flow chart indicating how the video signal display unit of the first embodiment performs process steps for displaying the video signal area in the input video signal on a monitor at a suitable magnification.

FIG. 4 is an explanatory view showing how the video signal display unit of the present invention performs area division to detect a non-picture area in an input video signal;

FIG. 5 is a block diagram illustrating the configuration of a video signal display unit according to a second embodiment of the present invention.

FIG. 6 is a flow chart indicating how the video signal display unit of the second embodiment performs process steps for displaying a video signal area in an input video signal on a monitor at a suitable magnification.

FIG. 7 is an explanatory view of a case in which a 4:3 letterbox image is input to the video signal display unit of the second embodiment of the present invention for display on a monitor with an aspect ratio of 16:9.

FIG. 8 is a block diagram illustrating the configuration of a video signal display unit according to a third embodiment of the present invention.

FIG. 9 is an explanatory view of a case in which a 4:3 letterbox image is input to the video signal display unit of the third embodiment of the present invention for display on a monitor with an aspect ratio of 16:9.

FIG. 10 illustrates the configuration of a conventional video signal display unit.

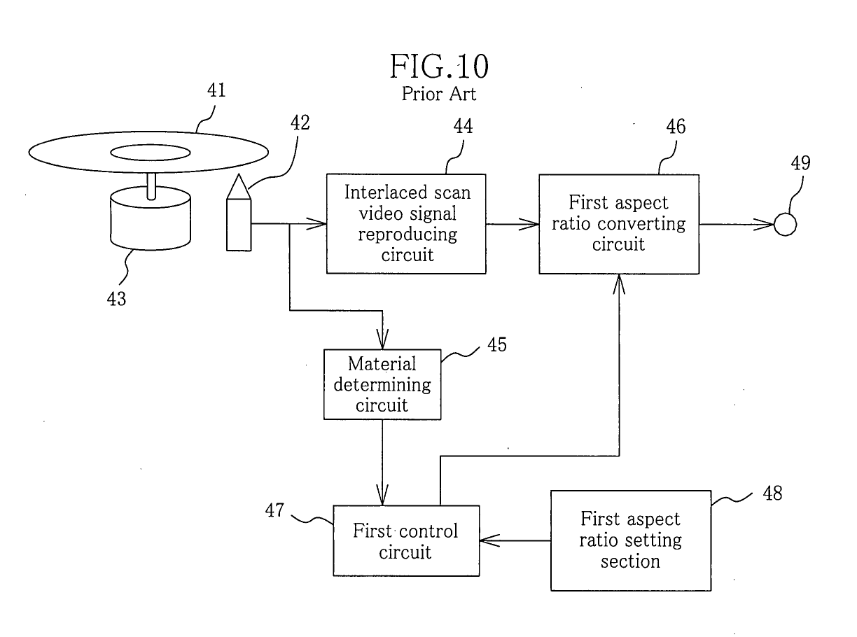

FIG. 11 is an explanatory view of a case in which a 4:3 letterbox image is input to the conventional video signal display unit for display on a monitor with an aspect ratio of 16:9.

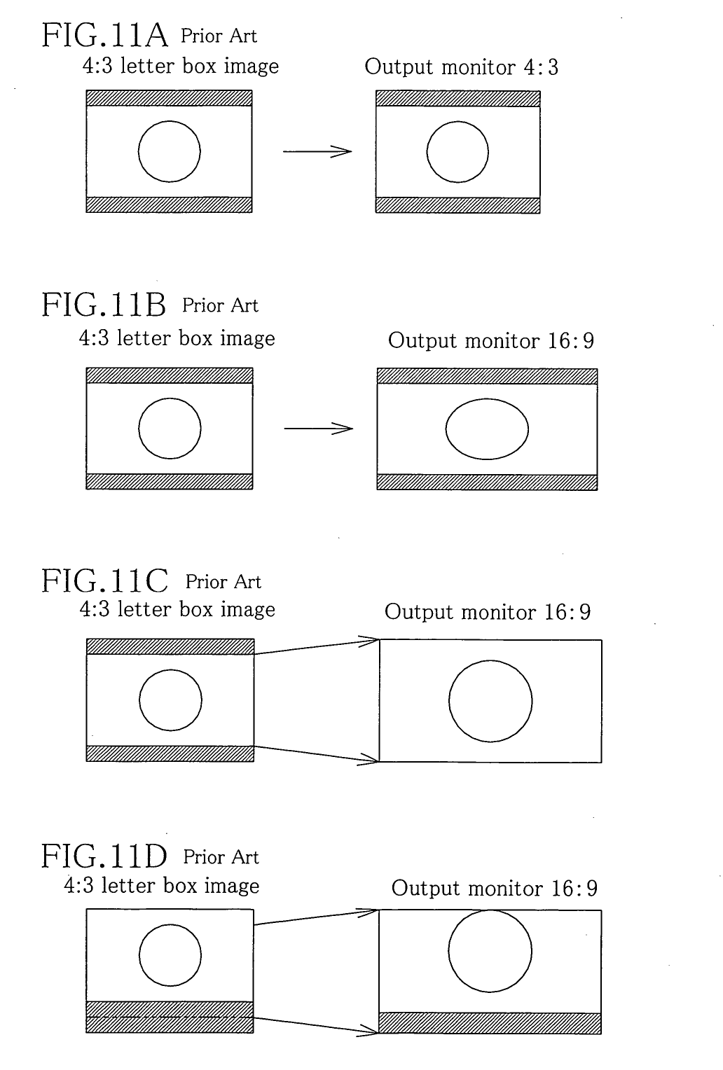

FIG. 12 is an explanatory view of a case in which a 4:3 letterbox image, in which character information is superimposed, is input to the conventional video signal display unit for display on a monitor with an aspect ratio of 16:9.

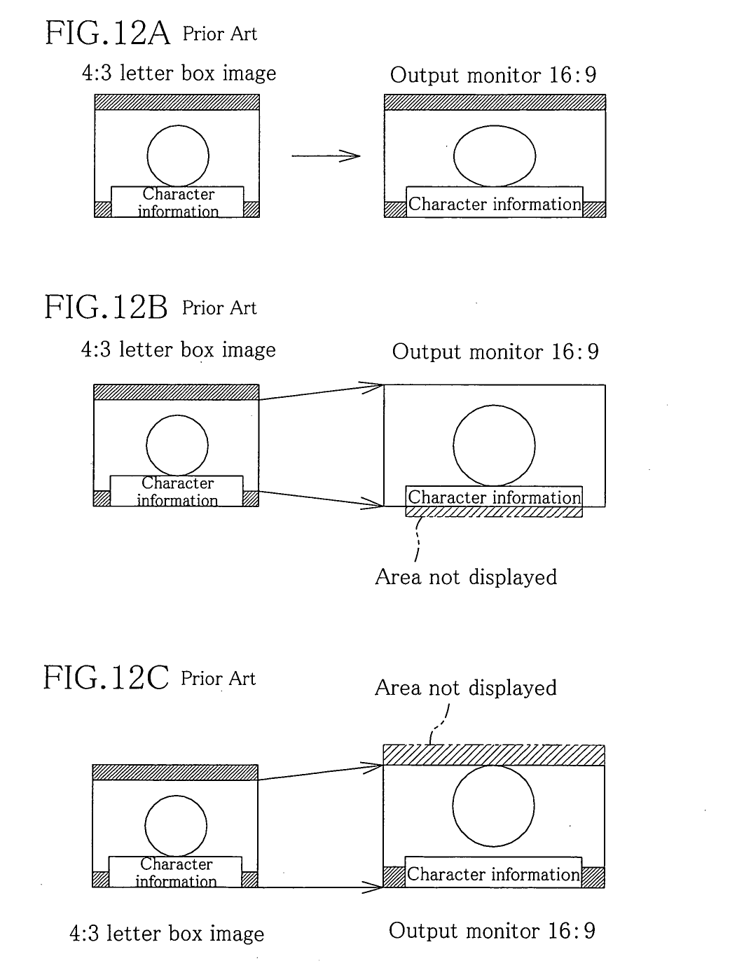

### DESCRIPTION OF THE PREFERRED EMBODIMENTS

Hereinafter, preferred embodiments of video signal display units according to the present invention will be described with reference to the accompanying drawings.

### First Embodiment

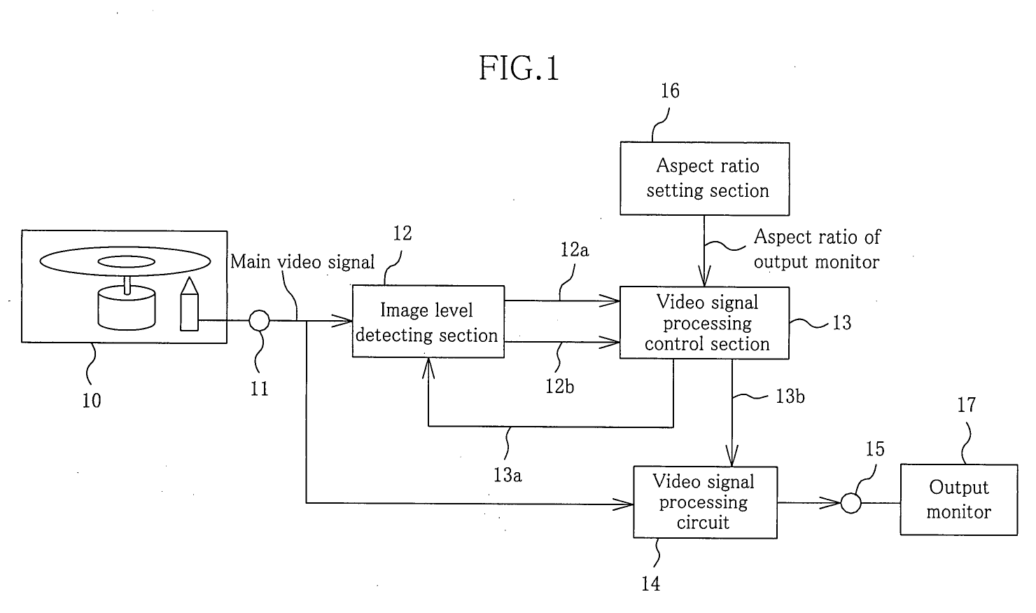

FIG. 1 is a block diagram illustrating the configuration of a video signal display unit according to a first embodiment of the present invention. As shown in FIG. 1, a video signal output section 10 reads an information signal recorded on a disc such as a DVD, transforms the information signal to an electrical signal, and outputs the electrical signal. The video signal output section 10 is connected through a video signal input terminal 11 to an image level detecting section 12 and a video signal processing circuit 14.

The image level detecting section 12 detects luminance signal levels in detection areas specified based upon a standard insert position where a non-picture area is inserted and upon a standard number of lines included in the non-picture area in one frame of an input video signal input from the video signal input terminal 11. The detection areas are changed one after another based on a first control signal 13a fed backed from a video signal processing control section 13, which will be discussed later.

The video signal processing control section 13 analyzes features of a main video signal based on the detection results obtained by the image level detecting section 12. The video signal processing control section 13 accumulates and analyzes data input for a predetermined number of frames, generates the first control signal 13a for respecifying the detection areas in the input video signal based on the analysis results, and outputs the first control signal 13a to the image level detecting section 12.

The video signal processing control section 13 also generates a second control signal 13b based on the aspect ratio of an output monitor 17 provided from an aspect ratio setting section 16 and on the detection area for the non-picture-area in the input video signal, and outputs the second control signal 13b to the video signal processing circuit 14. The second control signal 13b indicates the range of a video signal area to be clipped in the input video signal and the magnification at which the size of the video signal area is to be changed.

The video signal processing circuit 14 clips only the video signal area from the input video signal based on the second control signal 13b, while changing the size of the clipped image. The video signal whose size has been changed is output as an output video signal from a video signal output terminal 15 and displayed on the output monitor 17.

Hereinafter, it will be described how the video signal display unit of the first embodiment performs process steps for displaying a 4:3 letterbox image on a monitor with an aspect ratio of 16:9.

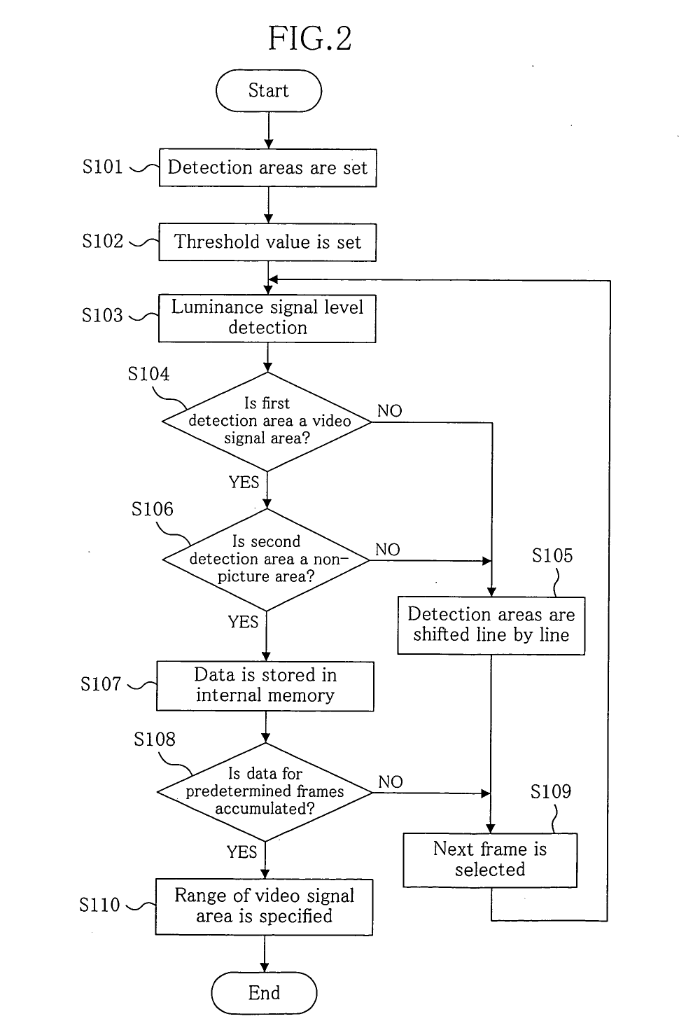

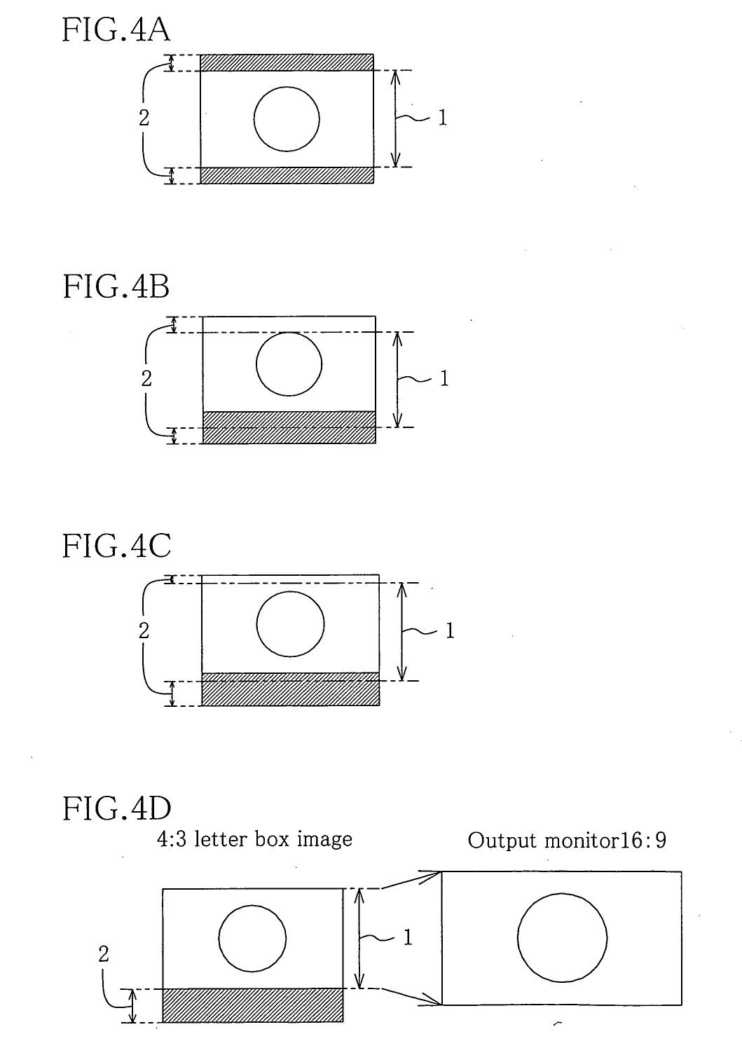

First, process steps for specifying the range of a video signal area in an input video signal will be described with reference to a flow chart shown in FIG. 2. As shown in FIG. 2, in a step S101, a first detection area 1 for detection of the video signal area and a second detection area 2 for detection of a non-picture area are each specified based on the number of lines in a single frame of the input video signal (see FIG. 4). When the first and second detection areas 1 and 2 are set for the first time after the input video signal is input, they are specified based on the standard insert position of the non-picture area in a single frame (see FIG. 4A), and thereafter they are respecified based on analysis results obtained by the video signal processing control section 13.

In a step S102, the threshold value of luminance signal levels in the first and second detection areas 1 and 2 is established. More specifically, in setting the threshold value, the upper and lower limits of pixel value for determining that a line(s) in the first or second detection area 1 or 2 is the non-picture area are TH1 and TH2, respectively.

In a step S103, the image level detecting section 12 detects luminance signal levels in the first and second detection areas 1 and 2 in the input video signal. Specifically, the detection of the luminance signal levels in the first and second detection areas 1 and 2 is performed line by line for each pixel. For the first detection area 1, the image level detecting section 12 generates a signal indicating at least one of a luminance signal average level Yave1, a luminance signal maximum level Ymax1, and a luminance signal minimum level Ymin1, and outputs the generated signal as a first detection result 12a to the video signal processing control section 13. Likewise, for the second detection area 2, the image level detecting section 12 generates a signal indicating at least one of a luminance signal average level Yave2, a luminance signal maximum level Ymax2, and a luminance signal minimum level Ymin2, and outputs the generated signal as a second detection result 12b to the video signal processing control section 13. The image level detecting section 12 typically detests the average levels Yave1 and Yave2.

In a step S104, the video signal processing control section 13 compares the first detection result 12a and the threshold values TH1 and TH2 to determine whether or not the luminance signal levels in the first detection area 1 indicate the video signal area. More specifically, the video signal processing control section 13 determines line by line whether or not the expressions TH1≦Yave1≦TH2, TH1≦Ymin1≦TH2, and TH1≦Ymax1≦TTH2 are satisfied.

If the determination in the step S104 is “Yes”, it is determined that the first detection area 1 that should be the video signal area contains a line(s) indicating the non-picture area (see FIG. 4B). As a result, the process branches to a step S105. In the step S105, the first and second detection areas 1 and 2 are shifted line by line and respecified (see FIG. 4C). It should be noted that the number of lines in each of the first and second detection areas 1 and 2 is not fixed but changed sequentially according to the result of the luminance signal level detection.

The process then proceeds to a step S109 where a next frame, for which luminance signal levels are to be detected, is selected, and then proceeds to the step S103 where the luminance signal level detection is performed for the selected next frame.

If the determination in the step S104 is “No”, the process branches to a step S106 where the second detection result 12b is compared with the threshold values TH1 and TH2 to determine whether or not the luminance signal levels in the second detection area 2 indicate the non-picture area. More specifically, it is determined line by line whether or not the expressions TH1≦Yave2≦TH2, TH1≦Ymin2≦TH2, and TH1≦Ymax2≦TH2 are satisfied.

If the determination in the step S106 is “No”, it is determined that the second detection area 2 that should be the non-picture area contains a line(s) indicating the video signal area (see FIG. 4B). As a result, the process branches to the step S105. If “Yes in the step S106, the process branches to a step S107 where the data on the first and second detection areas 1 and 2 are stored in an internal memory.

Then, in a step S108, it is determined whether or not all data for a predetermined number of frames is stored in the internal memory. If “No” in the step S108, it is determined that the detection results for the first and second detection areas 1 and 2 are still unstable, and the process branches to the step S109.

If the determination in the step S108 is “Yes”, the process branches to a step S110. In the step S110, based on the determination that the luminance signal levels detected are stable, the first and second detection areas 1 and 2 are determined and the range of the video signal area in the input video signal is specified (see FIG. 4D).

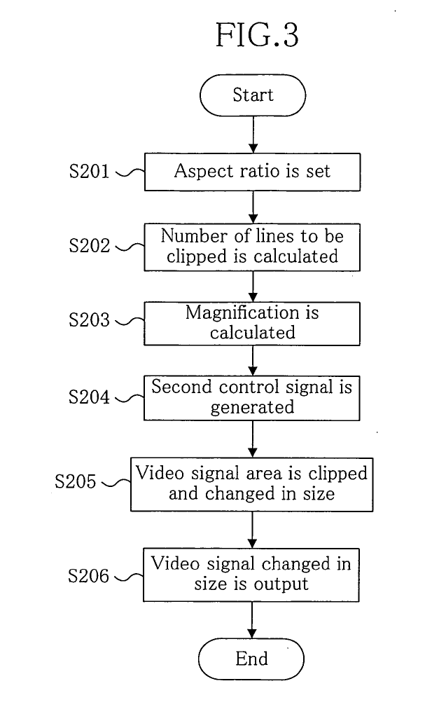

Next, process steps for displaying the 4:3 letterbox image on the monitor with an aspect ratio of 16:9 at a suitable magnification will be described with reference to a flow chart shown in FIG. 3. As shown in FIG. 3, in a step S201, the aspect ratio of the output monitor 17 is provided to the video signal processing control section 13 from the aspect ratio setting section 16. In the first embodiment, the aspect ratio of the output monitor 17 is 16:9.

In a step S202, the number of lines to be clipped for the video signal area is calculated based on the range of the video signal area specified in the input video signal. Subsequently, in a step S203, a magnification in the vertical direction for changing the size of the image of the video signal area to a size substantially equal to the screen size of the output monitor 17 is calculated based on the aspect ratio and the number of lines to be clipped. More specifically, the magnification is a value obtained by dividing the number of lines included in the display screen of the output monitor 17 by the number of lines to be clipped.

In a step S204, the video signal processing control section 13 generates and outputs a second control signal 13b to the video signal processing circuit 14. The second control signal 13b indicates the range of the video signal area to be clipped in the input video signal and the magnification for changing the size of the video signal area.

In a step S205, in the video signal processing circuit 14, the video signal area is clipped from the input video signal according to the second control signal 13b and the size of the clipped video signal area is changed in the vertical direction at the magnification. In a step S206, the video signal whose size has been changed is output as an output video signal from the video signal output terminal 15 and displayed on the output monitor 17.

As described above, as shown in FIG. 4D, in the video signal display unit of the first embodiment of the present invention, when the insert position of, and the number of lines in, a non-picture area contained in an input video signal do not have standard values, detection areas are shifted line by line in a plurality of frames and luminance signal levels detected for each detection area are analyzed and stored. This allows line-by-line determination of the positions and ranges of the non-picture area and video signal area, enabling an optimum separation position to be specified. In addition, the separated video signal area is enlarged at an optimum vertical magnification for displaying the video signal area in the same size as the screen size of the output monitor 17, whereby the original video signal area is displayed without losing any part thereof.

It should be noted that the number of parts into which the detection area is divided is not limited to two as shown in FIG. 4, but can be increased easily. The same is true in second and third embodiments described below.

Also, the aspect ratio of the video signal input to the video signal display unit of the present invention and the aspect ratio of the output monitor 17 are not limited to the standard ratios of 4:3 and 16:9, respectively. If the range of the area to be clipped from the input video signal and the magnification in the horizontal direction are changed, the video signal display unit of the present invention is applicable to cases where various other aspect ratios such as vista size and cinemascope size are used, and in those cases the same effects are obtained The same is also true in the following second and third embodiments.

### Second Embodiment

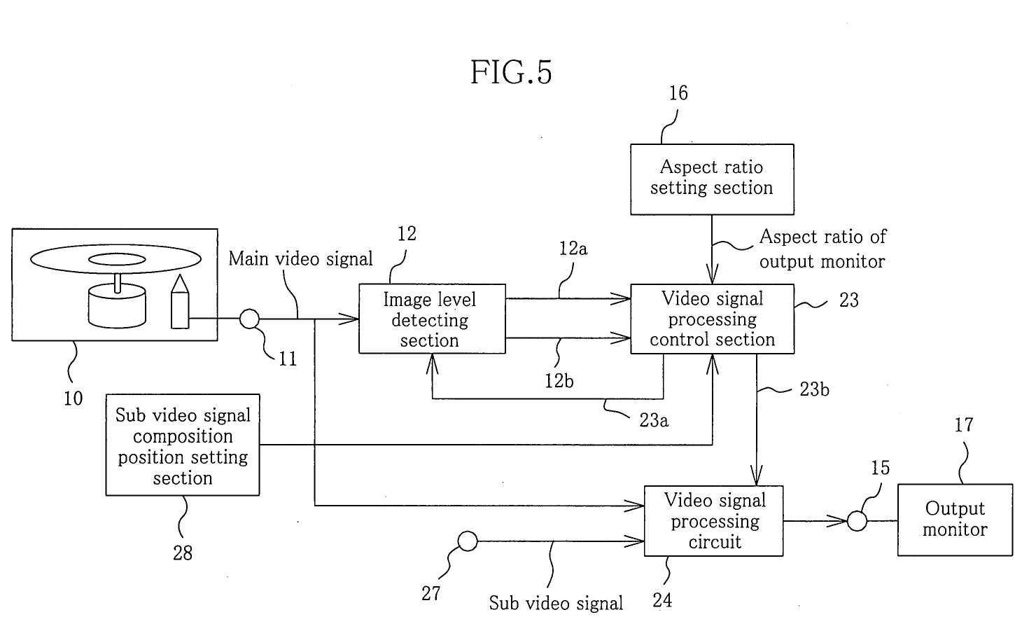

FIG. 5 is a block diagram illustrating the configuration of a video signal display unit according to a second embodiment of the present invention. The video signal display unit of the second embodiment differs from that of the first embodiment only in that a sub video signal is superimposed on a main video signal in the second embodiment. The same members as those shown in the first embodiment are thus identified by the same reference numerals and different members will be only described.

As shown in FIG. 5, a video signal processing circuit 24 is connected to a sub video signal input terminal 27, so that a sub video signal such as subtitle information is input to the video signal processing circuit 24. A video signal processing control section 23 is connected to a sub video signal composition position setting section 28 for setting a composition position in which the sub video signal is superimposed on a main video signal.

The video signal processing control section 23 analyzes features of the main video signal based on detection results obtained by an image level detecting section 12. The video signal processing control section 23 accumulates and analyzes data input for a predetermined number of frames, generates a first control signal 23a for specifying a detection area in the input video signal based on the analysis results, and outputs the first control signal 23a to the image level detecting section 12.

The video signal processing control section 23 also generates a second control signal 23b based on the aspect ratio of an output monitor 17 provided from an aspect ratio setting section 16 and on a detection area for a non-picture area in the input video signal, and outputs the second control signal 23b to the video signal processing circuit 24. The second control signal 23b indicates the range of a video signal area to be clipped in the input video signal, the magnification at which the size of the video signal area is changed, and the composition position, specified by the sub video signal composition position setting section 28, in which the sub video signal is superimposed on the main video signal.

The video signal processing circuit 24 clips only the video signal area from the input video signal based on the second control signal 23b, while changing the size of the clipped image. After the size of the main video signal has been changed, the video signal processing circuit 24 superimposes the sub video signal on the main video signal in the composition position specified by the sub video signal composition position setting section 28. The video signal on which the sub video signal has been overlaid after the size change process is output as an output video signal from a video signal output terminal 15 and displayed on the output monitor 17.

Hereinafter, it will be described how the video signal display unit of the second embodiment thus configured performs process steps for displaying a 4:3 letterbox image on a monitor with an aspect ratio of 16:9.

First, process steps for specifying the range of a video signal area in an input video signal, which are the same as those described in the first embodiment, are performed in accordance with the flow chart shown in FIG. 2.

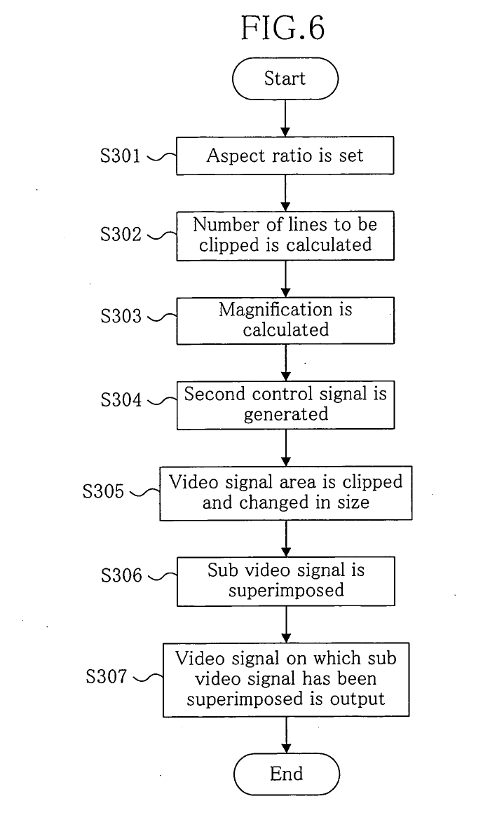

Next, referring to a flow chart shown in FIG. 6, it will be described how to carry out process steps for displaying the 4:3 letterbox image on the monitor with an aspect ratio of 16:9 at a suitable magnification and for performing superimposing of a sub video signal. As shown in FIG. 6, in a step S301, the aspect ratio of the output monitor 17 is provided from the aspect ratio setting section 16 to the video signal processing control section 23. In the second embodiment, the aspect ratio of the output monitor 17 is 16:9.

In a step S302, the number of lines to be clipped for the video signal area is calculated based on the range of the video signal area specified in the input video signal. In a step S303, a magnification in the vertical direction for changing the size of the image of the video signal area to a size substantially equal to the screen size of the output monitor 17 is calculated based on the aspect ratio and the number of lines to be clipped. More specifically, the magnification is a value obtained by dividing the number of lines in the display screen of the output monitor 17 by the number of lines to be clipped.

In a step S304, the video signal processing control section 23 generates and outputs a second control signal 23b to the video signal processing circuit 24. The second control signal 23b indicates the range of the video signal area to be clipped in the input video signal, the magnification at which the size of the video signal area is changed, and a composition position, specified by the sub video signal composition position setting section 28, in which the sub video signal is superimposed on the main video signal.

In a step S305, the video signal processing circuit 24 clips the video signal area from the input video signal based on the second control signal 23b and changes the size, in the vertical direction, of the clipped video signal area at the magnification.

In a step S306, based on the second control signal 23b, the sub video signal is superimposed on the magnified video signal in the specified composition position. In a step S307, the video signal on which the sub video signal has been overlaid is output as an output video signal from the video signal output terminal 15 and displayed on the output monitor 17.

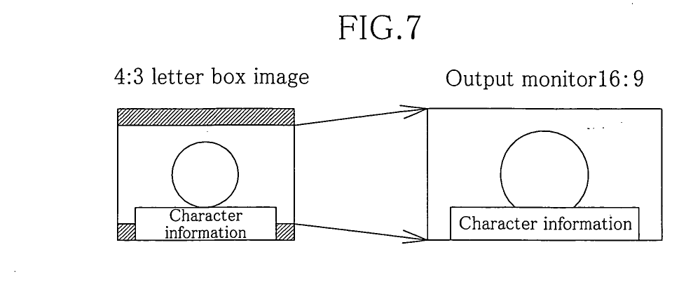

As mentioned above, as shown in FIG. 7, for example, even if character information (a sub video signal) is added to an input video signal (a main video signal) and a composition position in which the character information is superimposed on the input video signal is contained in a non-picture area in the input video signal, the video signal display unit of the second embodiment shifts the composition position into the display area in the input video signal, thereby displaying both the video signal and the character information without causing any disappearance thereof

### Third Embodiment

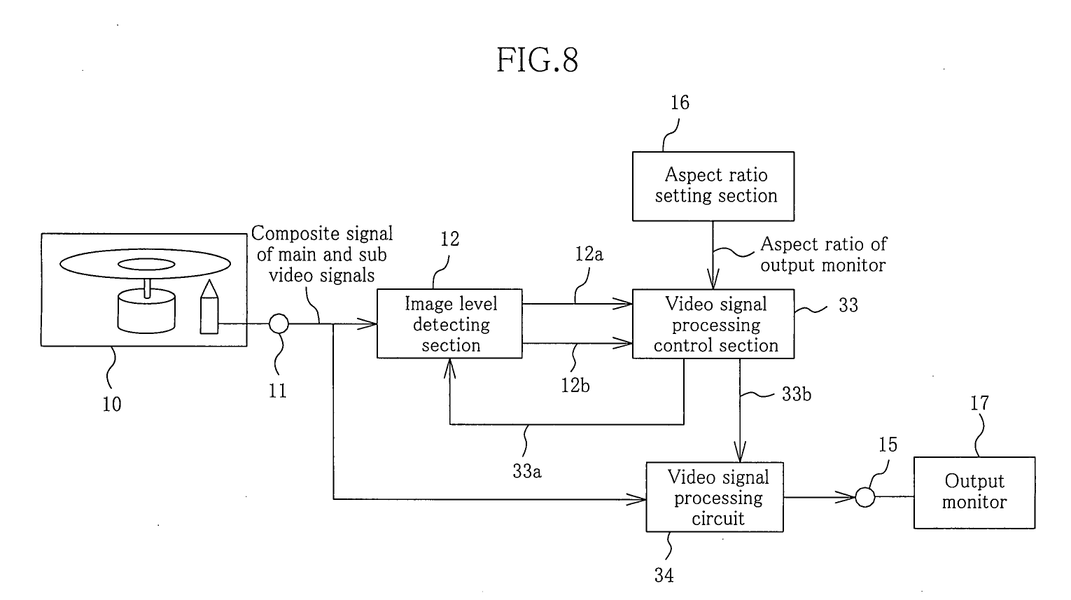

FIG. 8 is a block diagram illustrating the configuration of a video signal display unit according to a third embodiment of the present invention. The video signal display unit of the third embodiment differs from that of the first embodiment only in that a composite signal of a main video signal and a sub video signal is input from a video signal input terminal 11. The same members as those shown in the first embodiment are thus identified by the same reference numerals and different members will be only described.

As shown in FIG. 8, a composite video signal of a main video signal and a sub video signal is input to the video signal input terminal 11.

A video signal processing control section 33 analyzes features of the input video signal based on detection results obtained by an image level detecting section 12. The video signal processing control section 33 accumulates and analyzes data input for a predetermined number of frames, generates a first control signal 33a for specifying a detection area in the input video signal based on the analysis result, and outputs the first control signal 33a to the image level detecting section 12.

The video signal processing control section 33 also generates a second control signal 33b based on the aspect ratio of an output monitor 17 provided from an aspect ratio setting section 16 and on a detection area for a non-picture area in the input video signal, and outputs the second control signal 33b to a video signal processing circuit 34. The second control signal 33b indicates the range of a video signal area to be clipped in the input video signal and the magnification at which the size of the video signal area is changed.

It should be noted that the video signal display unit of the third embodiment is designed to determine that an area in the input video signal which includes at least either the main video signal or the sub video signal is the video signal area and the other area in the input video signal is the non-picture area.

The video signal processing circuit 34 clips only the video signal area from the input video signal based on the second control signal 33b, while changing the size of the clipped image. The video signal whose size has been changed is output as an output video signal from a video signal output terminal 15 and displayed on the output monitor 17.

To display a 4:3 letterbox image on a monitor with an aspect ratio of 16:9, the video signal display unit of the third embodiment performs the same process steps as those described in the first embodiment shown in the flow charts of FIGS. 2 and 3.

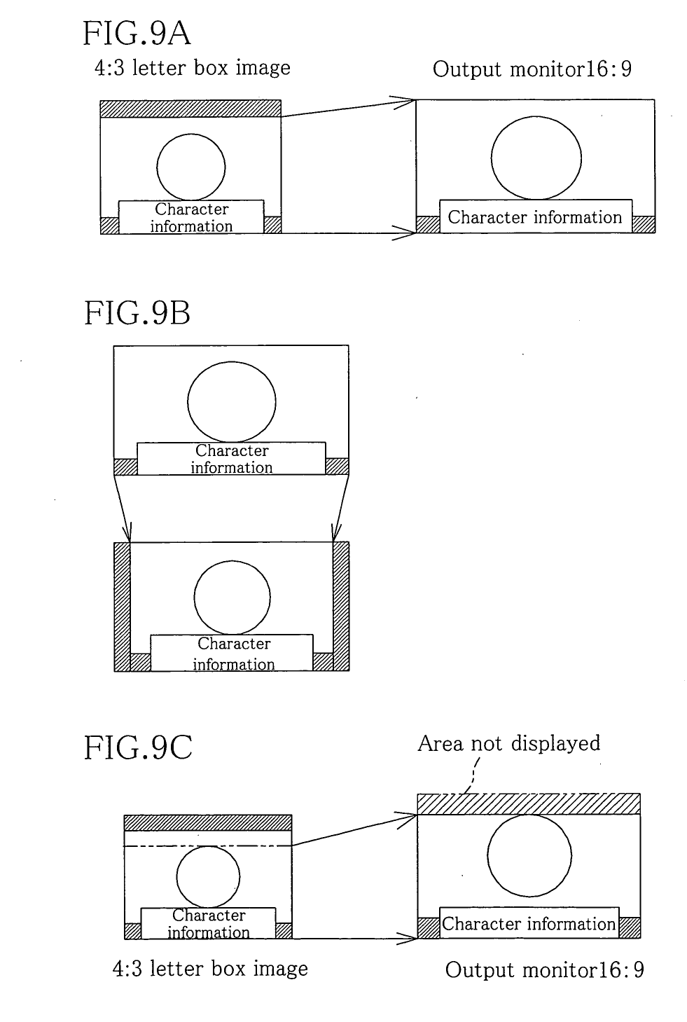

More specifically, as shown in FIG. 9A, suppose a case where a composite video signal is input in which character information (a sub video signal) is combined so as to overlap a non-picture area of the video signal (a main video signal) as well. In this case, in order to prevent the character information from disappearing, it is determined that the non-picture area containing the character information is also the video signal to be displayed, and an area including both the non-picture area and the video signal area is specified as the range of an area to be clipped. The signal area obtained by clipping that range of area is changed in size so as to be of the same size as the screen size of the output monitor 17.

It should be noted that the video signal processed in the manner shown in FIG. 9A may not be displayed at the correct aspect ratio in some cases. Thus, the video signal may be reduced in size in the horizontal direction as shown in FIG. 9B so as to be displayed at the correct aspect ratio.

Also, as shown in FIG. 9C, the clipping position may be optimized in consideration of the aspect ratio of the video signal at the time of output, so that the video signal can be displayed at the correct aspect ratio although the upper portion of the video signal disappears.

As mentioned above, when a composite video signal of character information and a video signal is input, the video signal display unit of the third embodiment considers that a non-picture area including the character information is also the video signal to be displayed, and determines the range of an area to be clipped as the video signal. The video signal display unit then changes the size of the video signal obtained by clipping that area range, so that the video signal has an optimum image size. Accordingly, the main video signal and the character information are displayed on the screen with no part thereof disappearing or with a disappearing part thereof, if any, being minimized.

The video signal display units of the present invention are not limited to cases in which video signals and sub video signals recorded on disc media are displayed, but may be applied to apparatuses for receiving and displaying television signals such as digital broadcast signals and terrestrial broadcast signals, and thus have effective applicability.

1. A video signal display unit comprising:
image-level detecting means for detecting line by line luminance signal levels in predetermined detection areas in an input video signal input from a video signal input terminal;
aspect-ratio setting means for setting an aspect ratio of an output monitor connected with a video signal output terminal;
video-signal processing control means for analyzing line positions of a video signal area and a non-picture area in the input video signal based on detection result obtained by the image-level detecting means, generating a first control signal for respecifying the detection areas based on result of the analysis, and outputting the first control signal to the image-level detecting means, and also for generating a second control signal indicating, based on the detection result and the aspect ration, a range of an area to be clipped as the video signal area in the input video signal and a magnification at which the range of the clipped area is changed in size; and
a video signal processing circuit for clipping only the video signal area from the input video signal based on the second control signal, magnifying the clipped video signal area at the magnification, and outputting the magnified video signal area to the video signal output terminal.

2. The unit of claim 1, wherein the video signal processing control means specifies the range of the area to be clipped as the video signal area, based on one of the detection areas which is for the non-picture area in the input video signal.

3. The unit of claim 1, wherein the image-level detecting means is configured to detect at least one of luminance signal average levels, luminance signal maximum levels, and luminance signal minimum levels in the detection areas in the input video signal, and
the video signal processing control means is configured to compare the luminance signal levels detected by the image-level detecting means with a threshold value established in advance, thereby determining whether the signal in the detection areas in the input video signal indicates the video signal area or the non-picture area.

4. The unit of claim 1, wherein the video signal input to the image-level detecting means and the video signal processing circuit is a main video signal or a composite signal in which the main video signal and a sub video signal are combined.

5. The unit of claim 1, wherein the second control signal controls the video signal processing circuit so that the size of an image obtained by clipping only the video signal area other than the non-picture area based on detection result in which a range of the non-picture area is detected for each of frames in the input video signal is changed to a size substantially equal to the screen size of an output monitor.

6. The unit of claim 1, wherein the second control signal controls the video signal processing circuit so that an image obtained by clipping the video signal area in such a manner that a disappearing portion of the video signal area is minimized, based on detection result in which a range of the non-picture area is detected for each of frames in the input video signal is enlarged at the predetermined magnification.

7. The unit of claim 1, further comprising sub video signal composition position setting means for setting a composition position in which a sub video signal is combined with a main video signal,
wherein the video signal processing control means is configured to generate the second control signal also indicating the composition position set by the sub video signal composition position setting means, when the main video signal is input to the video signal input terminal while the main video signal and the sub video signal are input to the video signal processing circuit, and
the video signal processing circuit is configured to combine the sub video signal with the main video signal in the composition position based on the second control signal, after the size of the main video signal has been changed.

8. The unit of claim 7, wherein the video signal processing circuit is configured so that when a display range of the sub video signal is contained in both a display range of the video signal area of the main video signal and a display range of the non-picture area, the video signal processing circuit shifts the display position of the sub video signal so that the display range of the sub video signal overlaps only the display range of the main video signal, before the video signal processing circuit combines the main video signal and the sub video signal.

9. The unit of claim 1, wherein the input video signal input from the video signal input terminal is a composite signal in which a main video signal and a sub video signal have been combined beforehand.

10. The unit of claim 9, wherein the video signal processing circuit is configured so that when a display range of the sub video signal is contained in both a display range of the video signal area and a display range of the non-picture area in the input video signal, the video signal processing circuit clips the display ranges of the video signal area and sub video signal area as the video signal area of the input video signal, and changes the size of the clipped video signal area.
